(19) United States
(12) Patent Application Publication
(10) Pub. No.: US 2014/0091488 A1
(43) Pub. Date: Apr. 3, 2014

(54) MICROSTRUCTURE FORMING MOLD AND OPTICAL ELEMENT MANUFACTURING METHOD

(71) Applicant: Olympus Corporation, Tokyo (JP)

(72) Inventor: MOTOAKI OZAKI, Tokyo (JP)

(73) Assignee: Olympus Corporation, Tokyo (JP)

(21) Appl. No.: 14/099,093

(22) Filed: Dec. 6, 2013

Related U.S. Application Data
(63) Continuation of application No. PCT/JP2012/071978, filed on Aug. 30, 2012.

(30) Foreign Application Priority Data
Sep. 16, 2011 (JP) 2011-203004

(51) Int. Cl. B29D 11/00

(52) U.S. Cl. CPC B29D 11/00798
USPC 264/2.4; 425/385

(57) ABSTRACT

This microstructure forming mold forms a concavoconvex reflection preventing part on a concave lens surface of a lens main body including the concave lens surface with curvature. The reflection preventing part is formed using a surface processing device including: a molding surface part that transfers the reflection preventing part; a base body part that supports the molding surface part in a bendable manner; and a cavity portion, an annular cavity portion, and a liquid supply unit that deform the base body part to bend the molding surface part.

This application is a continuation application based on PCT/JP2012/071978, filed on Aug. 30, 2012, claiming priority based on Japanese Patent Application No. 2011-203004, filed in Japan on Sep. 16, 2011. The contents of both the Japanese Patent Application and the PCT Application are incorporated herein by reference.

### TECHNICAL FIELD

The present invention relates to a microstructure forming mold and an optical element manufacturing method. For example, the present invention relates to a microstructure forming mold used to form the microstructure, such as a reflection preventing structure, and an optical element manufacturing method.

### BACKGROUND ART

In recent years, a reflection-preventing film is provided on a lens surface of an imaging lens of, for example, a camera or the like in order to prevent reflection of unnecessary light, such as a ghost or a flare.

As the reflection-preventing film provided on the surface of an optical element, such as the lens, for example, there is known a multilayer thin film on which a high refractive index layer and a low refractive index layer are alternately and appropriately superimposed on each other according to the wavelength of light at which reflection is prevented. Such a multilayer reflection-preventing film is formed by a vacuum process, such as vacuum evaporation or sputtering.

On the other hand, as a reflection preventing structure that is not based on such a multilayer thin film, as described in Japanese Unexamined Patent Application, First Publication No. 2006-317807, for example, there is known a reflection preventing structure in which a microstructure is formed in units of a triangular pyramid, a quadrangular pyramid, or the like on a lens surface so that refractive index variation occurs in the vicinity of the lens surface.

In Japanese Unexamined Patent Application, First Publication No. 2006-317807, an X-ray mask in which triangular prisms are arrayed at minute pitches is formed, and a resist coated on a lens via this X-ray mask is exposed X rays to form a triangular pyramidal microstructure on a lens surface. Then, by performing RF dry etching, the triangular pyramidal microstructure is transferred onto the lens surface to form a reflection preventing structure.

Additionally, Japanese Unexamined Patent Application, First Publication No. 2004-12856 describes a technique of molding a reflection preventing part in which fine conical convex portions are arranged substantially densely. In the technique in Japanese Unexamined Patent Application, First Publication No. 2004-12856, a thin layer of an etching rate gradient material is formed on a molding surface of a forming mold made of a glass plate, a photoresist film is formed on the surface of this thin layer, exposure and development are performed on this photoresist film, to form a mask with a predetermined pattern, and the etching rate gradient material layer is etched via this mask. This forms a forming mold that transfers the shape of the reflection preventing part. Then, by performing press molding using this forming mold, an optical element in which the shape of the reflection preventing part is transferred to the lens surface is formed.

### SUMMARY OF THE INVENTION

### Solution to Problem

According to a microstructure forming mold related to a first aspect of the present invention, there is provided a microstructure forming mold that forms a concavo-convex microstructure on a surface of a workpiece including the surface with curvature. The microstructure forming mold includes a molding surface part that transfers the microstructure; a base body part that supports the molding surface part in a bendable manner; and a mold-deforming part that deforms the base body part to bend the molding surface part.

According to the microstructure forming mold related to a second aspect of the present invention, in the aforementioned first aspect, the molding surface part may be processed with a shape that transfers the microstructure to the surface of the base body part.

According to the microstructure forming mold related to a third aspect of the present invention, in the aforementioned first or second aspect, the mold-deforming part may include at least one of a convex deformation part that causes the surface of the base body part to protrude so as to face a concave portion of the workpiece, and a concave deformation part that dents the surface of the base body part so as to face a convex portion of the workpiece.

According to the microstructure forming mold related to a fourth aspect of the present invention, in any one aspect of the above first to third aspects, the mold-deforming part may include a volume changing chamber that contains a fluid inside the base body part and allows at lease one of increase and reduction of volume according to a change in the pressure of the fluid, and pressure control part that changes the pressure of the fluid within the volume changing chamber.

According to the microstructure forming mold related to a fifth aspect of the present invention, in the above fourth aspect, the base body part may be configured by bonding a plurality of members that form the volume changing chamber.

According to the microstructure forming mold related to a sixth aspect of the present invention, in any one aspect of the above first to fifth aspects, the microstructure may be a reflection preventing structure in which pyramidal bodies are assembled.

According to an optical element manufacturing method related to a seventh aspect of the present invention, the optical element manufacturing method may include forming an optical element main body that is a workpiece having an optical surface with curvature on a surface thereof; coating molding resin on the optical surface; and pressing the molding surface part of the microstructure forming mold against the optical surface via the molding resin and transferring the shape of the molding surface part of the microstructure forming mold to the molding resin to thereby form the microstructure on the optical surface, in a state where the molding surface part is deformed in a shape resembling the shape of the optical surface by the mold-deforming part of the microstructure forming mold according to any one of the first aspect to sixth aspect.

### BRIEF DESCRIPTION OF DRAWINGS

FIG. 1A is a typical plan view showing the configuration of an optical element manufactured by an optical element manufacturing method of a first embodiment of the present invention.

FIG. 1B is an A-A cross-sectional view of FIG. 1A.

FIG. 1C is a detailed view of a B part of FIG. 1B.

FIG. 2A is a typical configuration view of a microstructure forming mold and a surface processing device in the first embodiment of the present invention.

FIG. 2B is a C-C cross-sectional view of FIG. 2A.

FIG. 2C is a detailed view of a D part of FIG. 2A.

FIG. 3A is a typical process explanatory view showing a manufacturing process of the microstructure forming mold of the first embodiment of the present invention.

FIG. 3B is a typical process explanatory view showing a manufacturing process, subsequent to FIG. 3A, of the microstructure forming mold of the first embodiment of the present invention.

FIG. 3C is a typical process explanatory view showing a manufacturing process, subsequent to FIG. 3B, of the microstructure forming mold of the first embodiment of the present invention.

FIG. 3D is a typical process explanatory view showing a manufacturing process, subsequent to FIG. 3C, of the microstructure forming mold of the first embodiment of the present invention.

FIG. 4A is a typical process explanatory view showing a manufacturing process, subsequent to FIG. 3D, of the microstructure forming mold of the first embodiment of the present invention.

FIG. 4B is a typical process explanatory view showing a manufacturing process, subsequent to FIG. 4A, of the microstructure forming mold of the first embodiment of the present invention.

FIG. 4C is a typical process explanatory view showing a manufacturing process, subsequent to FIG. 4B, of the microstructure forming mold of the first embodiment of the present invention.

FIG. 5 is a typical process explanatory view of a manufacturing method of an optical element of the first embodiment of the present invention.

FIG. 6 is a typical process explanatory view, subsequent to FIG. 5, of the manufacturing method of the optical element of the first embodiment of the present invention.

FIG. 7 is a typical process explanatory view, subsequent to FIG. 6, of the manufacturing method of the optical element of the first embodiment of the present invention.

FIG. 8A is a typical plan view showing an optical element manufactured by an optical element manufacturing method of a second embodiment of the present invention.

FIG. 8B is an E-E cross-sectional view of FIG. 8A.

FIG. 8C is a detailed view of an F part of FIG. 8B.

FIG. 9A is a typical configuration view of a microstructure forming mold and a surface processing device in the second embodiment of the present invention.

FIG. 9B is a G-G cross-sectional view of FIG. 9A.

FIG. 10 is an explanatory view of the operation of the microstructure forming mold of the second embodiment of the present invention.

FIG. 11A is a cross-sectional view showing the configuration of a microstructure forming mold of a modification example (first modification example) of the second embodiment of the present invention.

FIG. 11B is an H-H cross-sectional view of FIG. 11A.

FIG. 12A is a typical configuration view of a microstructure forming mold and a surface processing device in a third embodiment of the present invention.

FIG. 12B is a J-J cross-sectional view of FIG. 12A.

FIG. 13 is an explanatory view of the operation of a microstructure forming mold of the third embodiment of the present invention.

FIG. 14 is a typical configuration view showing the configuration of a microstructure forming mold of a modification example (second modification example) of the third embodiment of the present invention.

FIG. 15A is a typical configuration view of main portions of a microstructure forming mold of another modification example (third modification example) of the third embodiment of the present invention.

FIG. 15B is a K-K cross-sectional view of FIG. 15A.

### DESCRIPTION OF EMBODIMENTS

Hereinafter, embodiments of the present invention will be described with reference to the accompanying drawings. In all the drawings, even in the case of different embodiments, the same reference numerals will be given to the same or equivalent members, and a description thereof will be omitted here.

### First Embodiment

A microstructure forming mold of a first embodiment of the present invention will be described.

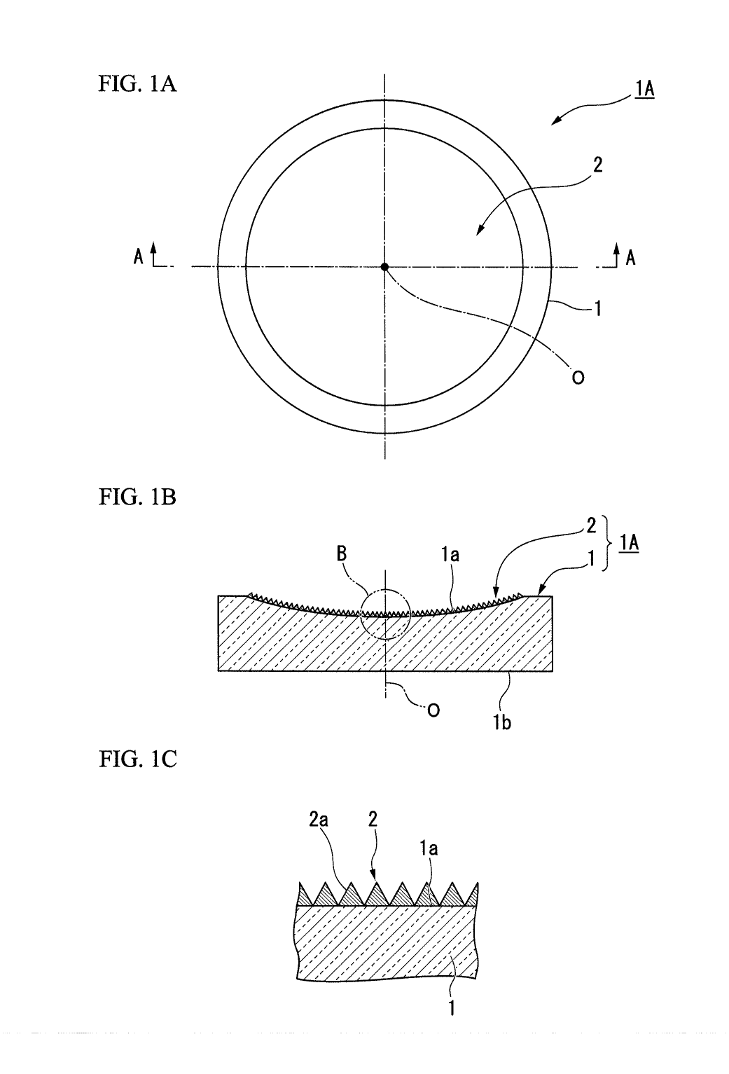

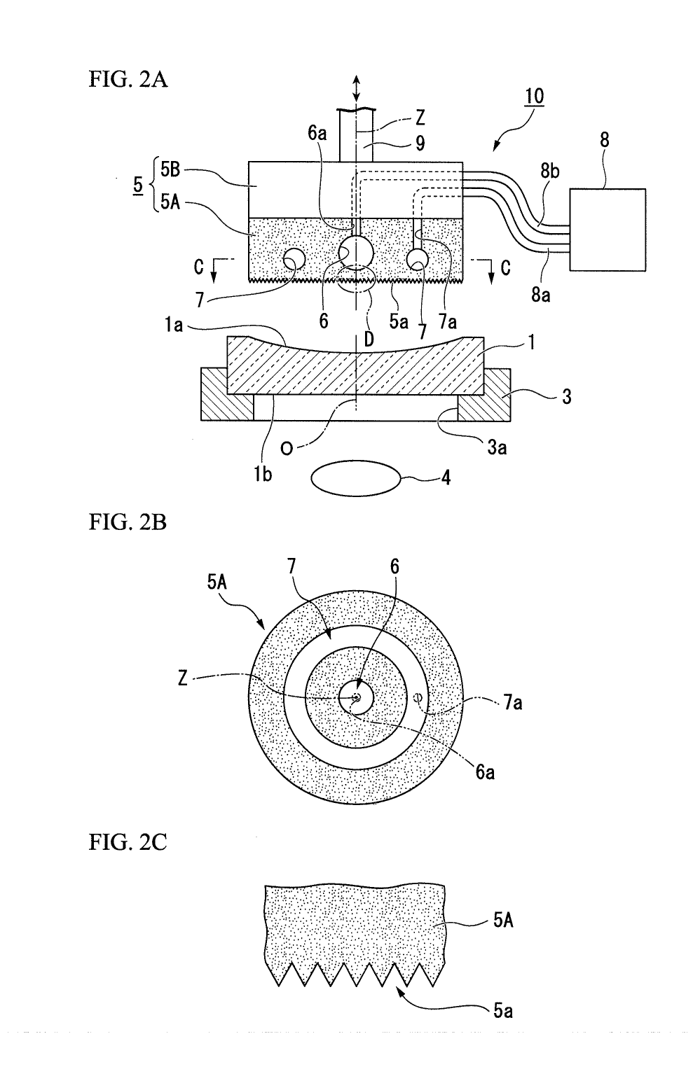

FIG. 1A is a typical plan view showing the configuration of an optical element manufactured by an optical element manufacturing method of the first embodiment of the present invention. FIG. 1B is an A-A cross-sectional view in FIG. 1A and FIG. 1C is a detailed view of a B part in FIG. 1A. FIG. 2A is a typical configuration view of the microstructure forming mold and a surface processing device in the first embodiment of the present invention. FIG. 2B is a C-C cross-sectional view in FIG. 2A and FIG. 2C is a detailed view of a D part in FIG. 2A.

The microstructure forming mold of the present embodiment is a mold used to form a microstructure having a concave portion and a convex portion in the surface of a workpiece with curvature.

The workpiece is not particularly limited if the workpiece is a member whose surface with curvature is subjected to surface processing that forms the concavo-convex microstructure. Additionally, the microstructure is not particularly limited if the microstructure has a shape capable of being formed by resin molding.

In the following, as an example, as shown in FIGS. 1A, 1B, and 1C, a case where the workpiece is a lens main body 1 (optical element main body) and the microstructure is a reflection preventing structure based on a reflection preventing part 2 will be described as an example.

That is, in the present embodiment, a case where the reflection preventing part 2 is formed in the lens main body 1 to manufacture a lens 1A that is the optical element will be described.

The lens main body 1 is a single plano-concave lens including a spherical concave lens surface 1a (a surface with curvature; an optical surface) and a plane lens surface 1b. According to the microstructure forming mold of the present embodiment, although the reflection preventing part 2 can be formed not only on the concave lens surface 1a but also on the plane lens surface 1b, a case where the reflection preventing part 2 is formed on the concave lens surface 1a will mainly be described.

Additionally, the concave lens surface 1a is processed with a surface shape and surface precision based on the design specification of the lens before the reflection preventing part 2 is formed. The design data of the surface shape is stored in advance in a fluid supply unit 8 of a surface processing device 10 to be described below.

The material of the lens main body 1 may be glass or synthetic resin. Additionally, a method of forming the concave lens surface 1a may be polishing or molding.

The reflection preventing part 2, as shown in FIG. 1C, is an aggregate of conical projections 2a that are densely arranged on the concave lens surface 1a. In the present embodiment, the reflection preventing part is formed from a UV-curable resin. As the kind of UV-curable resin, a material whose refractive index difference becomes as small as possible is selected according to the refractive index of the material of the lens main body 1. For example, in the present embodiment, when the lens main body 1 is a COP (cycloolefin polymer) resin (refractive index of 1.5), PAK-02 (tradename; made by Toyo Gosei Co. Ltd.; refractive index of 1.5) is adopted as the UV-curable resin.

The shape of the projections 2a can be appropriately set according to the targeted value of a wavelength or reflectivity in order to prevent reflection. In the present embodiment, as an example, in order to cause the reflectivity on the concave lens surface 1a of incident light with a wavelength of 380 nm to 780 nm to be equal to or less than 1%, the respective projections 2a have a shape such that the bottom surfaces thereof have a diameter of about 200 nm and the height thereof is about 200 nm, and are substantially uniformly arranged at adjacent pitches of about 200 nm.

The reflection of incident light is suppressed by virtue of such a configuration because the refractive index varies continuously from 1 to 1.5 within a range of 200 nm in height on the concave lens surface 1a.

In the present embodiment, such a lens 1A is manufactured by forming the reflection preventing part 2 on the concave lens surface 1a of the lens main body 1, using the surface processing device 10 shown in FIG. 2A.

The schematic configuration of the surface processing device 10 includes a holding part 3, a UV light source 4, and a microstructure forming mold 5, and a fluid supply unit 8 (pressure control part).

The holding part 3 holds the lens main body 1 when the surface processing is performed. In the present embodiment, the holding part 3 can hold an outer peripheral portion of the plane lens surface 1b and a lens side surface in a state where an optical axis O is aligned with the vertical axis and the concave lens surface 1a is directed upward.

A hole portion 3a that opens more largely than the lens effective diameter of the lens 1A is provided through a central portion of the holding part 3.

A positional relationship is established such that the central axis of the hole portion 3a is aligned with the optical axis O of the lens main body 1 held by the holding part 3.

The UV light source 4, which is a light source that irradiates the lens main body 1 with ultraviolet light (UV light), is used in order to cure the UV-curable resin coated on the concave lens surface 1a. In the present embodiment, the UV light source 4 is arranged at a position that overlaps the center of the hole portion 3a below the holding part 3. For this reason, UV light irradiated upward from the UV light source 4 passes through the hole portion 3a, enters the lens main body 1, and is irradiated onto the whole surface of the concave lens surface 1a.

The microstructure forming mold 5 has a flat and substantially columnar outer shape and is arranged above the holding part 3. A central axis Z of the microstructure forming mold 5 is arranged along the vertical axis, and is aligned with the optical axis O of the lens main body 1 held by the holding part 3.

Additionally, the microstructure forming mold 5 includes a base body part 5A and a base member 5B sequentially from a side (lower side) close to the holding part 3. The base body part 5A and the base member 5B have a disk-shaped outer shape with the same diameter.

An elevating arm 9 that is advanced and retracted along the vertical axis by a drive mechanism (not shown) is coupled to a central portion of an upper end portion of the base member 5B. For this reason, the microstructure forming mold 5 is movable to advance and retract along the vertical axis by advancing and retracting the elevating arm 9.

A molding surface part 5a used to transfer the shape of the reflection preventing part 2 is provided on a lower surface side of the base body part 5A. The molding surface part 5a has a concavo-convex shape obtained by reversing the concavo-convex shape of the reflection preventing part 2. Additionally, an upper surface of the base body part 5A is joined to a lower surface of the base member 5B.

In the present embodiment, the shape of the molding surface part 5a is a shape in which a number of conical holes obtained by reversing the shape of the projections 2a are formed in a plane on a lower end side (hereinafter referred to as a tip surface), and is a concave shape as a whole. Additionally, the molding surface part 5a includes a configuration in which a shape that transfers the reflection preventing part 2 is processed on the surface of the base body part 5A.

The material of the base body part 5A includes, for example, an elastic body, such as rubber or elastomer, which is easily deformed. For this reason, the base body part 5A bendably supports the molding surface part 5a.

In the present embodiment, as an example, rubber composed of a silicon compound is used as the material of the base body part 5A.

A cavity portion 6 and an annular cavity portion 7 are provided inside the base body part 5A at a position near the molding surface part 5a.

The cavity portion 6 is a spherical or vertically flat spheroidal space provided at a central portion (in a plan view) of the base body part 5A. A fluid supply passage 6a made of a metallic pipe or the like passes through an upper portion of the cavity portion 6, and inflow and discharge of a fluid is allowed between the cavity portion and the outside through the fluid supply passage 6a.

The annular cavity portion 7, which is an annular space having a circular or elliptical cross-section, is arranged at a position where a concentric circle is formed with respect to the cavity portion 6. A fluid supply passage 7a made of a metallic pipe or the like passes through an upper portion of the annular cavity portion 7, and inflow and discharge of a fluid are allowed between the annular cavity portion and the outside through the fluid supply passage 7a.

The base member 5B, which is a member that fixes an upper surface of the pliable microstructure forming mold 5, is made of, for example, a high-rigidity material that is not easily deformed compared to the base body part 5A, such as metal.

Additionally, the base member 5B has the function of decentralizing pressure on the upper surface of the base body part 5A when the pressure acts on the microstructure forming mold 5 from the elevating arm 9 with the elevating operation of the elevating arm 9.

The fluid supply passages 6a and 7a that extend upward from the base body part 5A are piped inside the base member 5B.

The fluid supply passages 6a and 7a each extend to the side surface of the base member 5B, respectively, and are connected to fluid supply pipes 8a and 8b having flexibility, respectively, on the side surface of the base member 5B.

The fluid supply unit 8 delivers or suctions a fluid to the fluid supply passages 6a and 7a via the fluid supply pipes 8a and 8b. Although illustration of the detailed configuration of the fluid supply unit 8 is omitted, the fluid supply unit includes, for example, a fluid storage part that stores a fluid, pump parts of two systems that independently deliver or suction a fluid to or from the fluid supply pipes 8a and 8b, respectively, and a pressure control part that controls the operations of the respective pump parts.

The fluid that the fluid supply unit 8 supplies may be, for example, gases, such as air, or for example liquids, such as water. In the present embodiment, as an example, the fluid supply unit 8 supplies air to the cavity portion 6 and the annular cavity portion 7 and controls air pressures within the cavity portion 6 and the annular cavity portion 7, thereby controlling the volumes of the cavity portion 6 and the annular cavity portion 7.

The cavity portion 6, the annular cavity portion 7, and the fluid supply unit 8 constitute a mold-deforming part that deforms the base body part 5A to bend the molding surface part 5a.

Additionally, the cavity portion 6 and the annular cavity portion 7 contain a fluid inside the base body part 5A, and constitute a volume changing chamber in which at least any of an increase or a reduction in volume is allowed depending on the pressure change of this fluid.

Additionally, the fluid supply unit 8 constitutes pressure control part that changes the pressure of a fluid within the volume changing chamber.

Next, an example of a method of manufacturing the base body part 5A will be described.

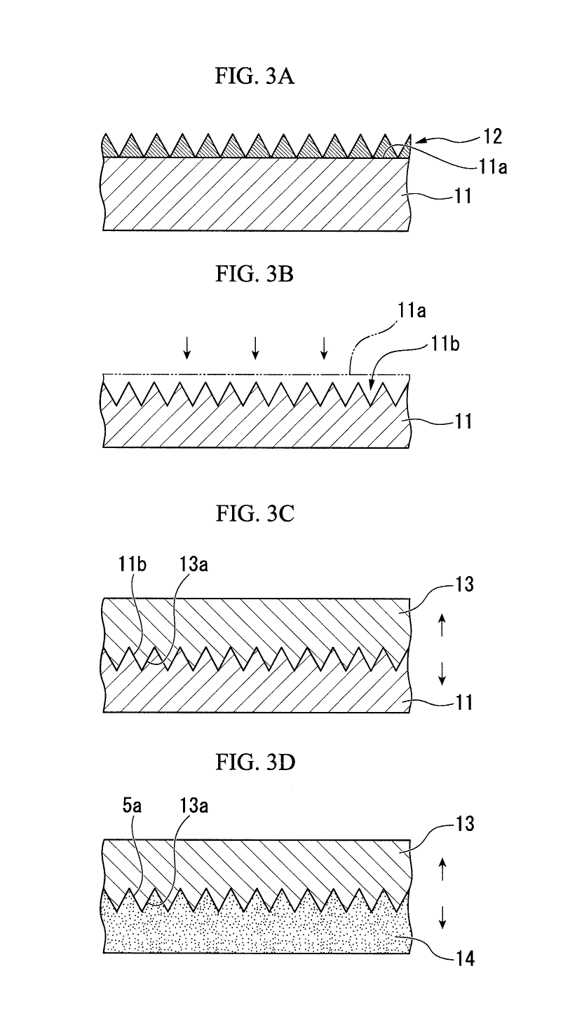

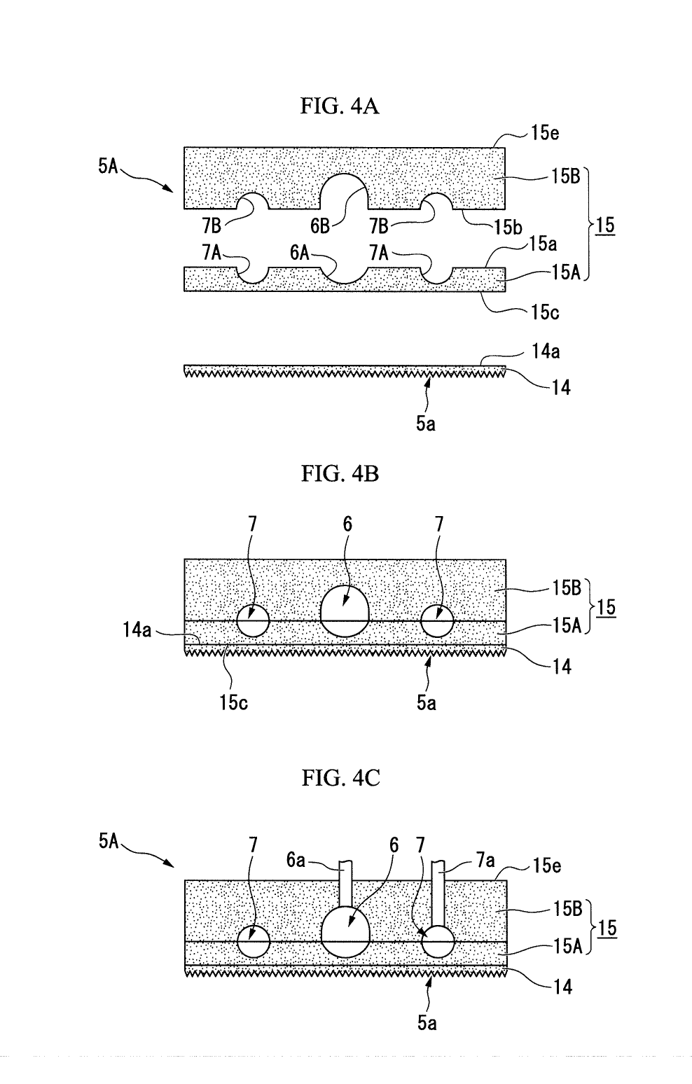

FIGS. 3A, 3B, 3C, and 3D are typical process explanatory views showing manufacturing processes of the microstructure forming mold of the first embodiment of the present invention. FIGS. 4A, 4B, and 4C are typical process explanatory views showing manufacturing processes, subsequent to FIG. 3D, of the microstructure forming mold of the first embodiment of the present invention. In FIGS. 3A, 3B, 3C, and 3D, main portions are shown as partially enlarged views for viewability.

In the present embodiment, as an example, as shown in FIG. 4A, the base body part 5A is manufactured by joining and integrating three members (a plurality of members that form the volume changing chamber) of a surface layer member 14, a first base body member 15A, and a second base body member 15B.

By dividing and manufacturing the base body part 5A in this way, a division can be made into a manufacturing process of the surface layer member 14 that requires microfabrication technology like nanoimprint technology, and a manufacturing process of the first base body member 15A and the second base body member 15B that can adopt general forming technology. Therefore, efficient manufacturing can be performed.

The surface layer member 14 is a sheet-like member made of rubber composed of a silicon compound. The molding surface part 5a is formed on one surface of the surface layer member 14, and the other surface of the surface layer member 14 includes a smooth plane. The surface layer member 14 is a member having a joining surface 14a that can be bonded and joined to the first base body member 15A.

In order to manufacture the surface layer member 14, as shown in FIG. 3A, a reversed microstructure main body 12 is formed on a base material surface 11a of a plate-shaped master base material 11 made of silicon.

The shape of the reversed microstructure main body 12 is a shape used to transfer the shape of the reflection preventing part 2 and is the same shape as the molding surface part 5a. That is, in the present embodiment, the surface shape of the reversed microstructure main body is a concave shape as a whole, in which the conical holes along the shape of the projections 2a are densely arranged.

The reversed microstructure main body 12 can be formed, for example, by removing an exposure portion after a resist is coated on the base material surface 11a and a shape pattern is exposed with an electron beam drawing apparatus.

Next, as shown in FIG. 3B, anisotropic etching, such as dry etching, is performed until the reversed microstructure main body 12 is removed. This allows the base material surface 11a to be etched along the outer shape of the reversed microstructure main body 12, and causes the surface shape of the reversed microstructure main body 12 to be transferred to the surface of the master base material 11. This allows a reversed microstructure portion 11b to be formed on a surface on the base material surface 11a side.

Hereinafter, the master base material 11 formed with the reversed microstructure portion 11b is referred to as a master mold 11A.

Next, as shown in FIG. 3C, a reversal mold 13 is formed using the master mold 11A as a matrix mold. The reversal mold 13 is formed, for example, by performing microstructure transfer of the UV-curable resin on a transparent and plane substrate, such as glass, using UV imprint. Additionally, a method of manufacturing the reversal mold 13 can also be manufactured by pressing the master mold 11A against a resin film under heating.

This allows the reversal mold 13 having the microstructure portion 13a with the reversed shape of the reversed microstructure portion 11b on the surface thereof to be obtained. The reversal mold 13 is plate-shaped as a whole. Since the shape of the microstructure portion 13a is a reversed shape of the reversed microstructure portion 11b, the shape of the microstructure portion is a convex shape as a whole, in which the same conical projections as the reflection preventing part 2 are densely arranged.

The manufacture of the master mold 11A may be omitted and manufacture may be performed from the reversal mold 13. However, in etching, manufacturing a concave shape is easier than manufacturing a convex shape, and shape accuracy is also excellent. For this reason, in the present embodiment, a manufacturing method that makes the master mold 11A with a concave shape is adopted.

Next, the reversal mold 13 is used as a matrix mold and nanoimprint technology is used to transfer the shape of the microstructure portion 13a to form the surface layer member 14.

The nanoimprint technology may include a heating method or a photo-curing method. The photo-curing method is adopted in the present embodiment. That is, the surface layer member 14 having the molding surface part 5a and the joining surface 14a can be formed by coating a photo (UV)-curable resin between the master mold 11A and the substrate to irradiate the resin with predetermined light.

The first base body member 15A and the second base body member 15B, as shown in FIG. 4A, are members having a shape obtained by dividing a disk-shaped member formed by removing the surface layer member 14 from the base body part 5A in a thickness direction (vertical direction in the drawing) in a plane passing through the center of the cavity portion 6 and the annular cavity portion 7.

For this reason, the first base body member 15A has a joining surface 15c including a smooth plane capable of being bonded and jointed to the joining surface 14a of the surface layer member 14, on one surface thereof in the thickness direction, and has a shape including the joining surface 15a including a smooth plane for being bonded and joined to the second base body member 15B, a hole 6A dented inward from the joining surface 15a, and an annular groove portion 7A, on the other surface thereof.

Additionally, the second base body member 15B has a joining surface 15b including a smooth plane capable of being bonded and jointed to the joining surface 15a of the first base body member 15A, a hole 6B dented inward from the joining surface 15b, and an annular groove portion 7B, on one surface thereof in the thickness direction, and has a shape including a joining surface 15e including a smooth plane for being bonded and joined to the base member 5B, on the other surface thereof.

Here, the hole 6A or the opening of the annular groove portion 7A and the hole 6B or the opening of the annular groove portion 7B have the same shape, respectively, and are formed so as to be arranged in the same positional relationship with respect to the center position of the first base body member 15A and the center position of the second base body member 15B.

The first base body member 15A and the second base body member 15B having such a configuration are manufactured by molding or machining, using the same material as the surface layer member 14. The first and second base body members can be manufactured by performing molding using molds that transfer respective outer shapes or by molding rubber composed of a silicon compound in the shape of a block and then forming the shapes of the holes 6A and 6B or the like through machining.

Next, as shown in FIG. 4B, the base body part main body 15 is formed by causing the first base body member 15A and the second base body member 15B to abut against and join to the joining surfaces 15a and 15b, respectively. Moreover, the joining surface 15c of the first base body member 15A and the joining surface 14a of the surface layer member 14 are caused to abut against and join to each other. This allows the base body part main body 15 and the surface layer member 14 to be integrated.

As a method of joining the joining surfaces, an appropriate joining method, by which a joining strength such that peeling-off does not occur even if the cavity portion 6 and the annular cavity portion 7 are deformed to certain degrees by controlling pressures therein as will be described below is obtained, can be adopted. In the present embodiment, activated joining using oxygen plasma is adopted as an example.

Next, as shown in FIG. 4C, the fluid supply passages 6a and 7a are formed by inserting metallic pipes so that they pass through the upper portions of the cavity portion 6 and the annular cavity portion 7, respectively, from the joining surface 15e of the base body part main body 15.

The base body part 5A is manufactured in this way.

In the base body part 5A, the fluid supply passages 6a and 7a arranged in advance within the base member 5B and the fluid supply passages 6a and 7a on the joining surface 15e side are connected, and the joining surface 15e is fixed to a lower surface of the base member 5B.

As a fixing method, for example, bonding can be adopted. However, when the second base body member 15B is manufactured, a joining member formed with a threaded portion, a fitting portion, or the like may be attached instead of the joining surface 15e so that the second base body member is detachably fixed to the base member 5B via this joining member.

The above-described method of manufacturing the base body part 5A is an example, and can be altered appropriately.

For example, when the master mold 11A is formed, selective etching, such as aluminum anodic oxidation, may be adopted instead of dry etching.

Next, the optical element manufacturing method of the present embodiment using the microstructure forming mold 5 of the present embodiment will be described.

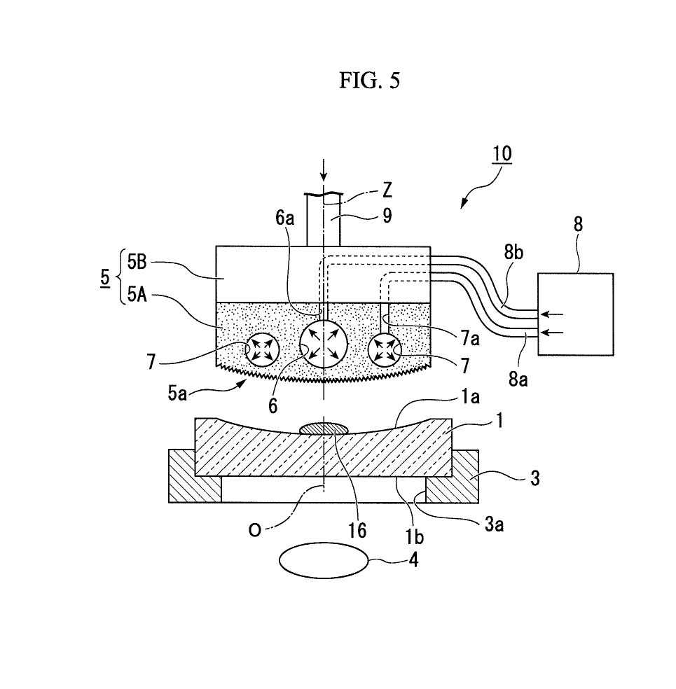

FIG. 5 is a typical process explanatory view of the manufacturing method of an optical element of the first embodiment of the present invention.

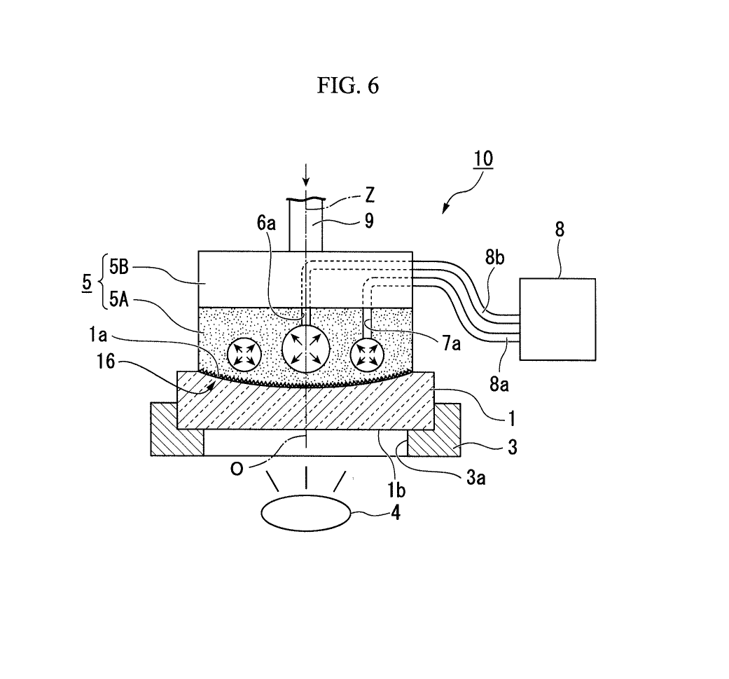

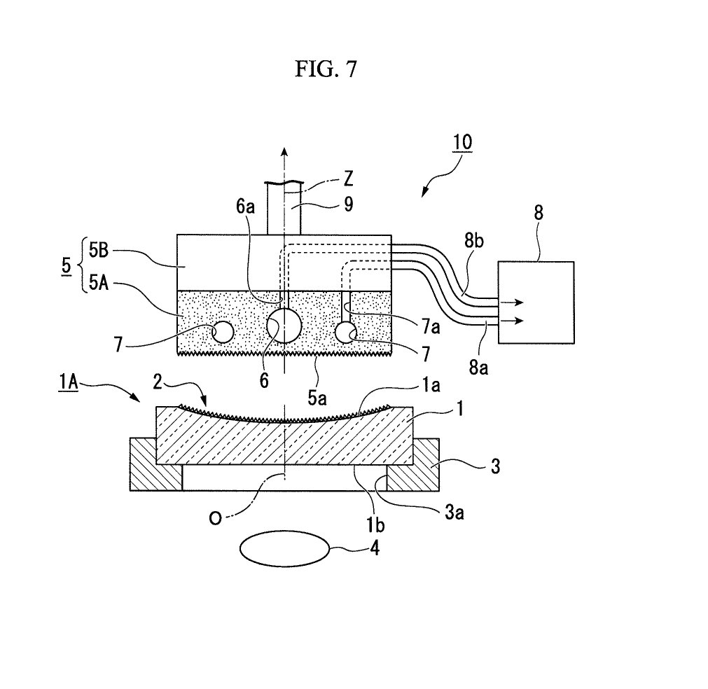

FIG. 6 is a typical process explanatory view, subsequent to FIG. 5, of the manufacturing method of the optical element of the first embodiment of the present invention. FIG. 7 is a typical process explanatory view, subsequent to FIG. 6, of the manufacturing method of the optical element of the first embodiment of the present invention.

In order to manufacture the lens 1A using this method, first, the lens main body 1 is formed, for example, by performing appropriate processing, such as cutting and polishing, glass mold molding, or resin molding.

Next, as shown in FIG. 5, the lens main body 1 is caused to be held by the holding part 3 of the surface processing device 10 in a posture where the concave lens surface 1a is directed to the microstructure forming mold 5.

Next, a UV-curable resin 16 (molding resin) is coated on the concave lens surface 1a. As for the kind of the UV-curable resin 16, in the present embodiment, PAK-02 (tradename) is used as an example.

As shown in FIG. 5, the UV-curable resin 16 may be coated in a lump on a central portion so as to spread to an outer peripheral portion in a process of pressing the microstructure forming mold 5 to be described below, or may be coated in the form of a layer on the whole concave lens surface 1a in advance, for example, by spin coating or the like.

By the time the coating of the UV-curable resin 16 is completed, the pressures within the cavity portion 6 and the annular cavity portion 7 are adjusted by the fluid supply unit 8, and the molding surface part 5a is deformed in a shape resembling the shape of the concave lens surface 1a. In the present embodiment, since the concave lens surface 1a is a concave spherical surface, the cavity portion 6 and the annular cavity portion 7 are expanded and deformed so as to have a convex spherical shape in which a central portion of the molding surface part 5a protrudes downward.

In this case, although it is preferable that the tip surface of the molding surface part 5a be the same spherical surface as the concave lens surface 1a, the microstructure forming mold 5 is an elastic body that is easily deformed because the microstructure forming mold is formed by bonding a rubber member composed of a silicon compound.

Accordingly, since the molding surface part 5a is deformed after the concave lens surface 1a during pressing to be described below, the shape of the tip surface during non-pressing may be a spherical surface with almost the same diameter as the concave lens surface 1a or a shape approximated to a spherical surface. However, when the tip surface of the molding surface part 5a does not become a spherical surface with the same shape as the concave lens surface 1a, it is more preferable that the molding surface part 5a have a shape such that the molding surface part abuts against the concave lens surface 1a from its surface top and a gap between the molding surface part and the concave lens surface 1a increases gradually toward an outer peripheral side. Spherically, it is more preferable that the tip surface of the molding surface part 5a have, for example, shapes, such as a spherical surface of which the curvature radius is slightly smaller than the curvature radius of the concave lens surface 1a or an aspheric surface of which the curvature radius decreases gradually from the central portion toward the outer peripheral side.

In the present embodiment, the correlation between the occurrence position of reflectivity variation after the formation of the reflection preventing part 2 and the pressure values of the cavity portion 6 and the annular cavity portion 7 is investigated experimentally, and target pressure values that allow the reflectivity variation to fall within an allowable range are set in the fluid supply unit 8.

In this way, the cavity portion 6 and the annular cavity portion 7 constitute a convex deformation part that causes the surface of the base body part to protrude so as to face the concave portion of a workpiece.

For this reason, the present embodiment is an example in which one concave portion of a workpiece is provided with a plurality of convex deformation parts.

Next, as shown in FIG. 6, the elevating arm 9 is lowered to press the molding surface part 5a of the microstructure forming mold 5 against the concave lens surface 1a via the UV-curable resin 16.

This allows the pliable molding surface part 5a to be deformed and brought into close contact with the concave lens surface 1a even when there is a difference between the shape of the tip surface of the molding surface part 5a and the shape of the concave lens surface 1a during non-pressing.

However, if a pressing force is too large, the shape of the hole of the molding surface part 5a is deformed and the shape error of the projections 2a of the reflection preventing part 2 is likely to occur.

Additionally, if the pressing force is too small, a residual film is easily generated because deformation of the molding surface part 5a becomes insufficient and a portion where the tip surface of the molding surface part 5a and the concave lens surface 1a do not abut against each other is created.

Both of these poor pressing forces result in poor shape of the reflection preventing part 2, which cause reflectivity variation to occur in the reflection preventing part 2. Thus, in the present embodiment, the pressing forces are set to be suitable pressing forces by performing the experiment of changing the viscosity of the UV-curable resin 16 and the pressing forces in advance to investigate the reflectivity variation of the reflection preventing part 2 and investigating the conditions of the viscosity of the UV-curable resin 16 and the pressing forces such that the reflectivity variation falls within an allowable range.

Next, the UV light source 4 is turned on in a state where the microstructure forming mold 5 is pressed against the concave lens surface 1a. This allows ultraviolet light to enter the lens main body 1 from the hole portion 3a and allows ultraviolet light to be emitted to the concave lens surface 1a from the inside of the lens main body 1.

This allows the UV-curable resin 16 filled into a space sandwiched between the concave lens surface 1a and the molding surface part 5a to be photo-cured and allows the reflection preventing part 2 to be formed on the concave lens surface 1a.

If the curing of the UV-curable resin 16 is completed, as shown in FIG. 7, the UV light source 4 is turned off, the elevating arm 9 is lifted, and the microstructure forming mold 5 is spaced apart from the concave lens surface 1a.

At this time, it is preferable to gradually reduce the pressures of the cavity portion 6 and the annular cavity portion 7 to return the molding surface part 5a to a shape before the deformation in parallel with the ascent. In this case, for example, if the sequential pressures of the cavity portion 6 and the annular cavity portion 7 are reduced gradually, first, the central portion of the molding surface part 5a is pulled upward due to reduction of the cavity portion 6. For this reason, since mold release proceeds gradually toward the outer peripheral side from the central portion of the molding surface part 5a, compared to a case where the entire microstructure forming mold 5 is released from the reflection preventing part 2, mold release resistance decreases and the shape accuracy of the reflection preventing part 2 can be improved.

The lens 1A in which the concave lens surface 1a is formed with the reflection preventing part 2 is manufactured in this way.

When the reflection preventing part is also provided on the plane lens surface 1b by the surface processing device 10, the reflection preventing part can be formed, similar to the above, by causing the lens 1A to be reversed and held by the holding part 3 and by adjusting the pressures of the cavity portion 6 and the annular cavity portion 7 so that the molding surface part 5a becomes a substantial plane.

In the surface processing device 10 including the microstructure forming mold 5 of the present embodiment, the shape of the molding surface part 5a can be changed by adjusting the pressures of fluids within the cavity portion 6 and the annular cavity portion 7. For this reason, the reflection preventing part 2 can also be formed, for example, on a concave lens surface of which the curvature radius is different from the curvature radius of the concave lens surface 1a, with high precision, because the molding surface part 5a can be brought into close contact with and pressed against the surface of the workpiece simply by changing the pressures of fluids within the cavity portion 6 and the annular cavity portion 7 using the fluid supply unit 8.

Accordingly, formation of the reflection preventing part 2 can be successively performed on a lens main body with a different lens surface shape without preparing other microstructure forming molds or without replacing the microstructure forming mold 5 with other microstructure forming molds. For this reason, even if the surface shapes of workpieces vary, the reflection preventing structure can be easily and rapidly formed on the surfaces of the workpieces.

As a result, the manufacturing costs of optical elements including the reflection preventing part can be reduced.

### Second Embodiment

A microstructure forming mold of a second embodiment of the present invention will be described.

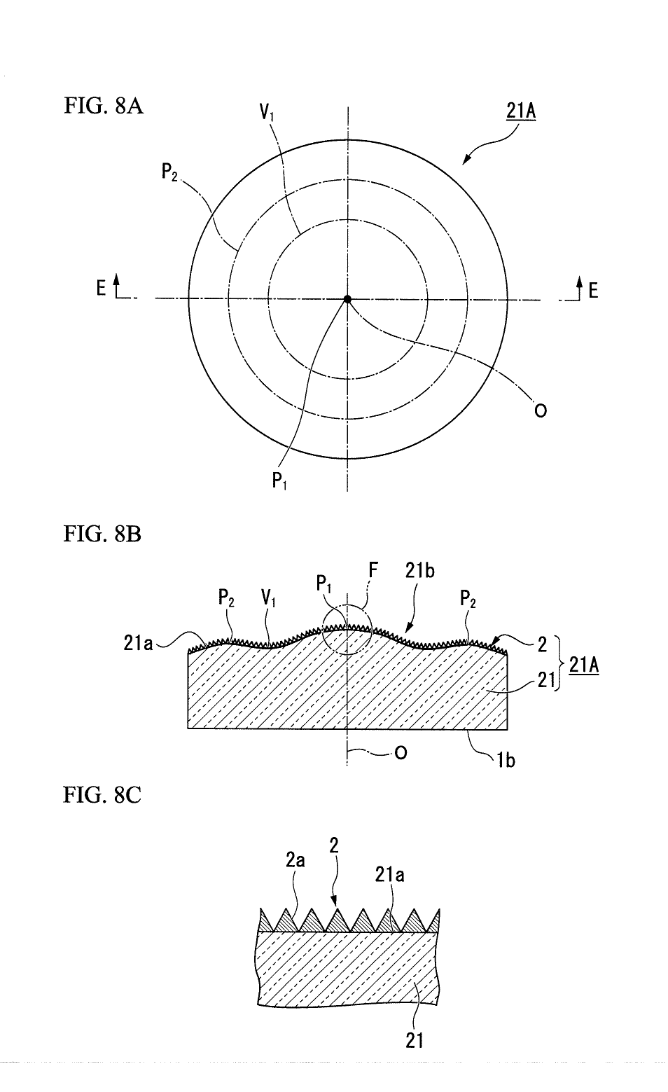

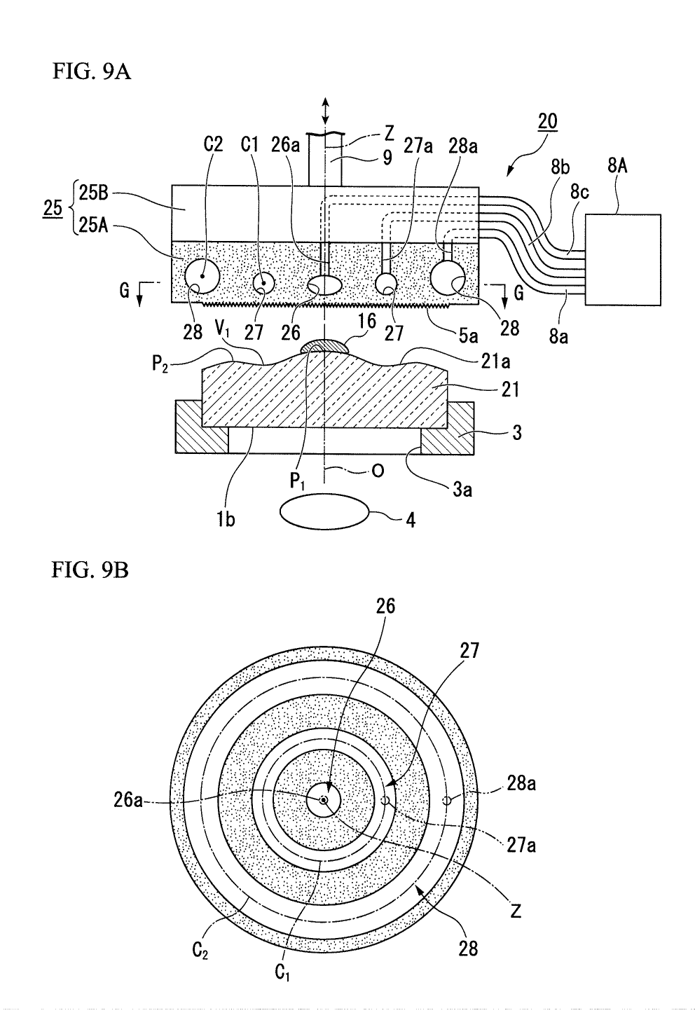

FIG. 8A is a typical plan view showing the configuration of an optical element manufactured by an optical element manufacturing method of the second embodiment of the present invention. FIG. 8B is an E-E cross-sectional view in FIG. 8A and FIG. 8C is a detailed view of an F part in FIG. 8A. FIG. 9A is a typical configuration view of a microstructure forming mold and a surface processing device in the second embodiment of the present invention. FIG. 9B is a G-G cross-sectional view in FIG. 9A.

Although a microstructure forming mold 25 (refer to FIG. 9A) of the present embodiment is a mold that forms the reflection preventing part 2 on the surface of the workpiece, similar to the above first embodiment, the microstructure forming mold 25 is a mold that enables the reflection preventing part 2 to be formed on a workpiece having a shape on the surface of which irregularities are mixedly present, instead of the concave lens surface 1a of the lens main body 1 in the above first embodiment.

In the following, a case where a lens main body 21 shown in FIGS. 8A, 8B, and 8C is used as an example of the workpiece will be described as an example.

The lens main body 21 is a single aspheric lens including an aspheric lens surface 21a (a surface with curvature; an optical surface), and a plane lens surface 1b, and has positive refractive power as a whole.

In the aspheric lens surface 21a, a partial concave surface is formed at an outer periphery of a partial convex surface centered on an optical axis O, and a partial convex surface is formed at an outer periphery of this concave surface. The aspheric lens surface 21a is a rotationally symmetric aspheric surface that has a convex surface shape as a whole. Here, the partial convex surface and the partial concave surface mean, for example, a concavo-convex relationship with respect to an approximated spherical surface of the aspheric lens surface 21a. In FIGS. 8A and 8B, the peak positions (positions where the length of a leg drawn to the approximated spherical surface becomes the maximum) of these convex surface, concave surface, and convex surface are shown as a surface top P1, valley bottom line V1, and a ridgeline P2, respectively.

Such an aspheric lens can be used for, for example, a portion of an imaging lens system configured by a plurality of lenses.

Additionally, according to the microstructure forming mold 25 of the present embodiment, similar to the microstructure forming mold 5 of the above first embodiment, the reflection preventing part 2 can also be formed on the plane lens surface 1b. In the following, however, a case where the reflection preventing part 2 is formed on the aspheric lens surface 21a will mainly be described.

Additionally, the aspheric lens surface 21a is processed with a surface shape and surface precision based on the design specification of the lens before the reflection preventing part 2 is formed. The design data of the surface shape is stored in advance in a fluid supply unit 8A of a surface processing device 20 to be described below.

The material of the lens main body 21 may be glass or synthetic resin. Additionally, a method of forming the aspheric lens surface 21a may be polishing or molding.

In the present embodiment, such a lens 21A is manufactured by forming the reflection preventing part 2 on the aspheric lens surface 21a of the lens main body 21, using the surface processing device 20 shown in FIG. 9A.

In the surface processing device 20, the microstructure forming mold 5 and the fluid supply unit 8 in the surface processing device 10 of the above first embodiment are replaced with the microstructure forming mold 25 and the fluid supply unit 8A (pressure control part). Hereinafter, differences from the above first embodiment will mainly be described.

The microstructure forming mold 25 includes a base body part 25A and a base member 25B instead of the base body part 5A and the base member 5B of the microstructure forming mold 5.

The base body part 25A is made of an elastic body, such as rubber or elastomer, which is easily deformed, and is formed from the same material as the base body part 5A of the above first embodiment. However, the base body part includes a cavity portion 26 and annular cavity portions 27 and 28 instead of the cavity portion 6 and the annular cavity portion 7 of the base body part 5A.

The cavity portion 26 is a vertically flat spheroidal space provided at a central portion (in a plan view) of the base body part 25A. A fluid supply passage 26a made of a metallic pipe or the like passes through an upper portion of the cavity portion 26, and inflow and discharge of a fluid is allowed between the cavity portion and the outside through the fluid supply passage 26a. In the present embodiment, particularly, there is provided the function of discharging a fluid to deform the molding surface part 5a in a partial concave shape.

The annular cavity portion 27, which is an annular space having a circular or elliptical cross-section, is arranged at a position centered on a circle C1 that forms a concentric circle with respect to the cavity portion 26, as shown in FIG. 9B. Additionally, a fluid supply passage 27a made of a metallic pipe or the like passes through an upper portion of the annular cavity portion 27, and inflow and discharge of a fluid are allowed between the annular cavity portion and the outside through the fluid supply passage 27a. In the present embodiment, particularly, there is provided the function of causing a fluid to flow into the annular cavity portion so as to deform the molding surface part 5a in a partial convex shape with a circular shape in a plan view. Here, the circle C1 is set at a position that substantially faces the valley bottom line V1 of the lens main body 21.

The annular cavity portion 28, which is an annular space having a circular or elliptical cross-section, is arranged at a position centered on a circle C2 that forms a concentric circle with respect to the cavity portion 26 and has a larger diameter than the circle C1 as shown in FIG. 9B. Additionally, a fluid supply passage 28a made of a metallic pipe or the like passes through an upper portion of the annular cavity portion 28, and inflow and discharge of a fluid are allowed between the annular cavity portion and the outside through the fluid supply passage 28a. In the present embodiment, particularly, there is provided the function of causing a fluid to flow into the annular cavity portion so as to deform the molding surface part 5a in a partial convex shape with a circular shape in a plan view. Here, the circle C2 is set at a position that is closer to the outer peripheral side than the ridgeline P2 of the lens main body 21 and that is closer to the outer peripheral side than the outer shape of the lens main body 21.

Such a base body part 25A having such a configuration is different from the base body part 5A of the above first embodiment in terms of only the shape or arrangement of the cavity portion 26 and, annular cavity portions 27 and 28 thereof, and can be manufactured substantially similar to the base body part 5A.

By virtue of such configuration, the cavity portion 26 is arranged at a position that faces the surface top P1 of the lens main body 21 held by the holding part 3. Additionally, the annular cavity portion 27 is arranged at a position that substantially faces the partial concave surface of the aspheric lens surface 21a. Additionally, the annular cavity portions 27 and 28 are arranged in a concentrical shape in a positional relationship in which the ridgeline P2 is sandwiched between the inner peripheral side and the outer peripheral side.

The base member 25B is the same member as the base member 5B of the above first embodiment, and is different from the base member 5B in that the fluid supply passages 26a, 27a, and 28a extending upward from the base body part 25A are piped inside the base member instead of the fluid supply passages 6a and 7a.

The fluid supply passages 26a, 27a, and 28a extend to the side surface of the base member 25B, respectively, and are connected to fluid supply pipes 8a, 8b, and 8c having flexibility, respectively, on the side surface of the base member 25B.

The fluid supply unit 8A includes the same configuration as the fluid supply unit 8 except that the fluid supply unit delivers or suctions a fluid to/from the fluid supply passages 26a, 27a, and 28a via the fluid supply pipes 8a, 8b, and 8c, and includes pump parts of three systems and a pressure control part that controls the operations of the respective pump parts.

Accordingly, the fluid supply unit 8A supplies air to the cavity portion 26 and the annular cavity portions 27 and 28 and controls air pressures therein, so that the volumes of the cavity portion 26 and the annular cavity portions 27 and 28 can be controlled.

The cavity portion 26, the annular cavity portions 27 and 28, and the fluid supply unit 8A constitute a mold-deforming part that deforms the base body part 25A to bend the molding surface part 5a.

Additionally, the cavity portion 26 and the annular cavity portions 27 and 28 change the volume changing chamber, and the fluid supply unit 8A constitutes pressure control part that changes the pressure of a fluid within the volume changing chamber.

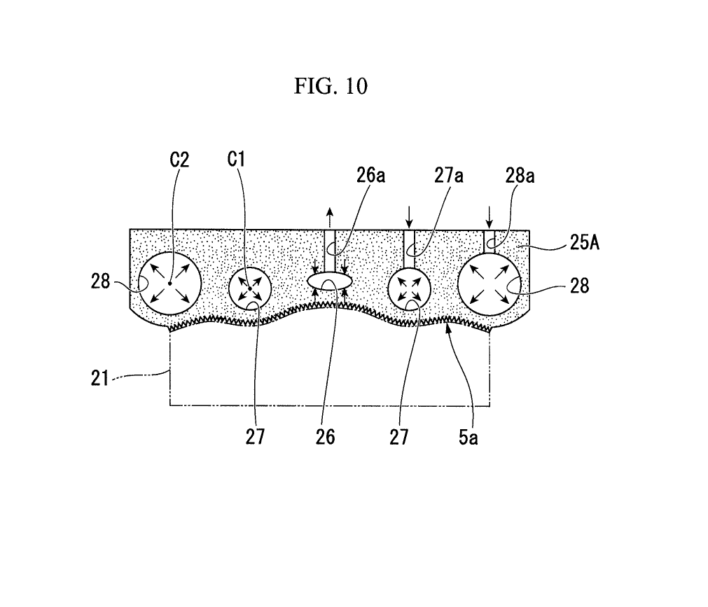

Next, the optical element manufacturing method of the present embodiment using the microstructure forming mold 25 of the present embodiment will be described with a focus on differences from the above first embodiment. FIG. 10 is an explanatory view of the operation of the microstructure forming mold of the second embodiment of the present invention.

In order to manufacture the lens 21A using this method, first, the lens main body 21 is formed, for example, by performing appropriate processing, such as cutting and polishing, glass mold molding, or resin molding.

Next, as shown in FIG. 9A, the lens main body 21 is caused to be held by the holding part 3 of the surface processing device 20 in a posture where the aspheric lens surface 21a is directed to the microstructure forming mold 25.

Next, the UV-curable resin 16 is coated on the aspheric lens surface 21a, similar to the above first embodiment.

On the other hand, by the time the coating of the UV-curable resin 16 is completed, the pressures within the cavity portion 26 and the annular cavity portions 27 and 28 are adjusted by the fluid supply unit 8A, and the molding surface part 5a is deformed in a shape resembling the shape of the aspheric lens surface 21a.

In the present embodiment, since the aspheric lens surface 21a is a rotationally symmetric aspheric surface including a concavo-convex surface, which has a convex surface shape as a whole, as shown in FIG. 10, a concave portion is formed at the central portion of the molding surface part 5a by contracting the cavity portion 26. Additionally, the molding surface part 5a protrudes downward in the drawing in the vicinity of the annular cavity portion 27 by expanding the annular cavity portions 27 and 28. This allows a partial convex surface with a circular shape in a plan view to be formed at the molding surface part 5a.

Similarly, since the molding surface part 5a protrudes downward in the drawing in the vicinity of the annular cavity portion 28, a partial convex surface with a circular shape in a plan view is formed at the molding surface part 5a. This allows a partial concave surface with a circular shape in a plan view to be formed between the annular cavity portions 27 and 28.

Due to such deformation, a concave shape obtained by the shape of an outer edge portion of the lens main body 21 being reversed is formed in a region between the circle C2 and the circle C1 (refer to the lens main body 21 shown by two-dot chain line of FIG. 10).

In this case, although it is preferable that the tip surface of the molding surface part 5a becomes an aspheric surface with the same shape as the aspheric lens surface 21a, similar to the above first embodiment, the microstructure forming mold 25 is formed from the elastic body that is easily deformed. Therefore, the shape of the tip surface during non-pressing may be a shape approximated to the aspheric lens surface 21a.

The pressure values of the cavity portion 26 and the annular cavity portions 27 and 28, in which preferable approximated shapes are obtained, are set in the fluid supply unit 8A as target pressure values that allow the reflectivity variation to fall within an allowable range by experimentally investigating the correlation between the occurrence position of reflectivity variation after the formation of the reflection preventing part 2 and the pressure values of the cavity portion 26 and the annular cavity portions 27 and 28, similar to the above first embodiment.

In this way, the cavity portion 26 constitutes a concave deformation part that dents the surface of the base body part so as to face the convex portion of a workpiece. Additionally, the annular cavity portion 27 constitutes a convex deformation part that causes the surface of the base body part to protrude so as to face a concave portion of the workpiece.

For this reason, the present embodiment is an example in which one concave deformation part is provided for one convex portion of a workpiece and one convex deformation part is provided for one concave portion of the workpiece.

Additionally, the present embodiment is an example in which the annular cavity portions 27 and 28 can form a concave portion by the combination of two convex deformation parts therebetween.

Subsequently, the reflection preventing part 2 is formed on the aspheric lens surface 21a by performing the process of pressing the microstructure forming mold 25 against the aspheric lens surface 21a, and the process of turning on the UV light source 4 in a state where the microstructure forming mold 25 is pressed against the aspheric lens surface 21a to cure the UV-curable resin 16 filled into a space sandwiched by the aspheric lens surface 21a and the molding surface part 5a, similar to the above first embodiment.

If the curing of the UV-curable resin 16 is completed, the microstructure forming mold 25 is spaced apart from the aspheric lens surface 21a, similar to the above first embodiment.

At this time, it is preferable to gradually reduce the pressures of the cavity portion 26 and the annular cavity portions 27 and 28 to return the molding surface part 5a to a shape before the deformation in parallel with the ascent.

In the present embodiment, since the aspheric lens surface 21a is a convex surface as a whole, it is preferable to gradually reduce the pressures in order of the annular cavity portions 28 and 27 first and gradually increase the pressure of the cavity portion 26 finally to perform mold release sequentially from the outer peripheral side of the aspheric lens surface 21a.

The lens 21A in which the aspheric lens surface 21a is formed with the reflection preventing part 2 is manufactured in this way. Even in the surface processing device 20, the reflection preventing part 2 can be provided on the plane lens surface 1b, similar to the surface processing device 10 of the above first embodiment.

In the surface processing device 20 including the microstructure forming mold 25 in this way, the shape of the molding surface part 5a can be changed by adjusting the pressures of fluids within the cavity portion 26 and the annular cavity portions 27 and 28. For this reason, for example, even in a case where the shape of a curved surface is different from that of the aspheric lens surface 21a if an aspheric surface in which a convex surface, a concave surface, and a convex surface are formed from the center toward the outer periphery is provided, the molding surface part 5a can be brought into close contact with and pressed against the surface of the workpiece simply by changing the pressures of fluids within the cavity portion 26 and the annular cavity portions 27 and 28 using the fluid supply unit 8A. For this reason, the reflection preventing part 2 can be formed with high precision.

Accordingly, the reflection preventing part 2 can be successively formed on a lens main body with a different lens surface shape without preparing other microstructure forming molds or without replacing the microstructure forming mold 25 with other microstructure forming molds. For this reason, even if the surface shapes of workpieces vary, the reflection preventing structure can be easily and rapidly formed on the surfaces of the workpieces.

As a result, the manufacturing costs of optical elements including the reflection preventing part can be reduced.

### First Modification Example

Next, a microstructure forming mold of a modification example (first modification example) of the second embodiment of the present invention will be described.

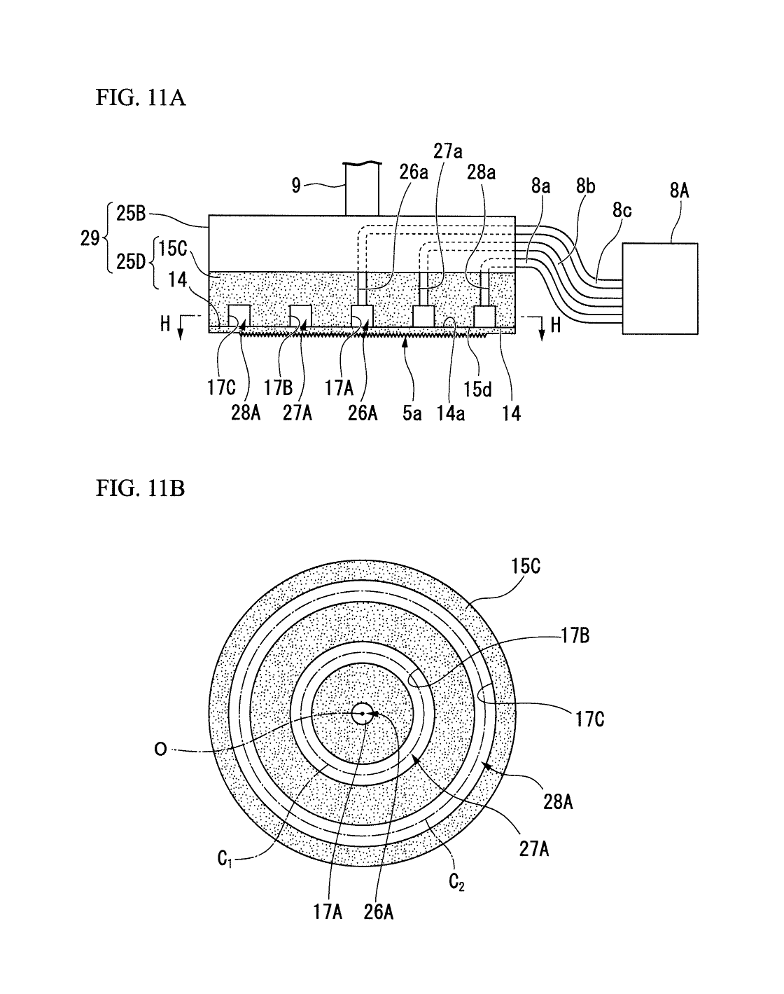

FIG. 11A is a cross-sectional view showing the configuration of the microstructure forming mold of the modification example (first modification example) of the second embodiment of the present invention. FIG. 11B is an H-H cross-sectional view in FIG. 11A.

A microstructure forming mold 29 of the present modification example, as shown in FIGS. 11A and 11B, includes a base body part 25D that has the same outer shape as the base body part 25A and has the molding surface part 5a on a lower end face thereof, instead of the base body part 25A of the microstructure forming mold 25 of the above second embodiment.

The microstructure forming mold 29 can be used instead of the microstructure forming mold 25 in the surface processing device 20 of the above second embodiment.

Hereinafter, differences from the above second embodiment will mainly be described.

The base body part 25D is made of an elastic body, such as rubber or elastomer, which is easily deformed, and is formed from the same material as the base body part 25A of the above second embodiment. However, the base body part includes a cavity portion 26A and annular cavity portions 27A and 28A instead of the cavity portion 26 and the annular cavity portions 27 and 28 of the base body part 25A.

The cavity portion 26A is provided at the same position as the cavity portion 26, and is different from the cavity portion 26 in that the cavity portion 26A is a vertically flat columnar space. The fluid supply passage 26a passes through an upper portion of the cavity portion 26A, similar to the cavity portion 26.

The annular cavity portions 27A and 28A are provided at the same positions as the annular cavity portions 27 and 28, respectively, and are different from the annular cavity portions 27 and 28 in that the cavity portions 27A and 28A are annular spaces having a rectangular cross-section. The fluid supply passage 27a and 28a pass through upper portions of the annular cavity portions 27A and 28A, respectively.

The base body part 25D having such configuration is formed by the base body member 15C and the surface layer member 14 being joined to each other.

The base body member 15C is, for example, a member obtained by forming a circular hole 17A and annular angled groove portions 17B and 17C corresponding to the shapes of the cavity portion 26A and the annular cavity portions 27A and 28A, respectively, on one surface, in the thickness direction, of a disk member made of rubber composed of a silicon compound.

The circular hole 17A and the annular angled groove portions 17B and 17C can be formed by molding or machining, similar to the hole 6A and the annular groove portion 7A of the above first embodiment.

The surface layer member 14 is joined to the surface of the base body member 15C where the circular hole 17A and the annular angled groove portions 17B and 17C are formed, similar to the first base body member 15A and the second base body member 15B of the above first embodiment.

This allows the openings of the circular hole 17A and the annular angled groove portions 17B and 17C to be blocked, thereby forming the cavity portion 26A and the annular cavity portions 27A and 28A that are deformable according to the pressures of fluids supplied from the fluid supply passages 26a, 27a, and 28a.

In the present modification example, in order to manufacture the lens 21A of the above second embodiment, the cavity portion 26A has the function of causing a fluid to flow into the cavity portion 26A so as to deform the molding surface part 5a in a partial convex shape with a circular shape in a plan view. In the present embodiment, the annular cavity portions 27A and 28A have the function of causing a fluid to flow into the annular cavity portions 27A and 28A so as to deform the molding surface part 5a in a partial convex shape with a circular shape in a plan view.

According to the microstructure forming mold 29 having such a configuration, the reflection preventing part 2 can be formed on the aspheric lens surface 21a of the lens main body 21, similar to the above second embodiment by using the microstructure forming mold 29 instead of the microstructure forming mold 25 of the surface processing device 20.

The present modification example is an example in which the cross-sectional shape of the volume changing chamber is rectangular.

### Third Embodiment

A microstructure forming mold of a third embodiment of the present invention will be described.

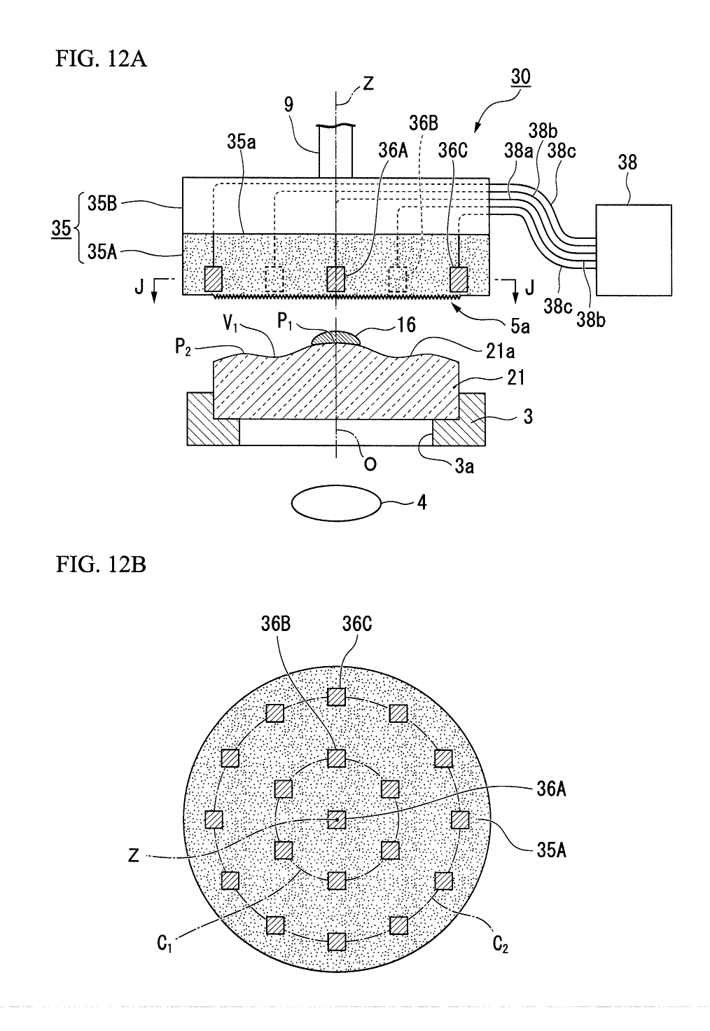

FIG. 12A is a typical configuration view of a microstructure forming mold and a surface processing device in the third embodiment of the present invention. FIG. 12B is a J-J cross-sectional view in FIG. 12A.

A microstructure forming mold 35 of the present embodiment, as shown in FIG. 12A, is a mold that forms the reflection preventing part 2 on the surface of a workpiece like the above second embodiment by being used for a surface processing device 30.

The surface processing device 30 includes the microstructure forming mold 35 and a piezoelectric element control unit 38, instead of the microstructure forming mold 25 and the fluid supply unit 8A of surface processing device 20 of the above second embodiment.

Hereinafter, differences from the above second embodiment will mainly be described.

The microstructure forming mold 35 includes a base body part 35A and a base member 35B instead of the base body part 25A and the base member 25B of the microstructure forming mold 25 of the above second embodiment.

The base body part 35A is made of an elastic body that is the same material as the base body part 25A and is easily deformed, and has the substantially same disk-shaped outer shape. That is, the molding surface part 5a is formed on one surface of the base body part in the thickness direction, and a joining surface 35a joined to a lower surface of the base member 35B is formed on the other surface of the base body part.

A piezoelectric element 36A is buried at a position near the molding surface part 5a at a central portion in a plan view inside the base body part 35A. Additionally, a plurality of piezoelectric elements 36B and 36C are buried at positions where each circumference are equally divided, at positions near the molding surface part 5a on the circles C1 and C2 of the above second embodiment.

The piezoelectric elements 36A, 36B, and 36C when voltages are applied take a posture where the expanding/contracting directions thereof run along the thickness direction of the base body part 35A, and are buried in a state where the piezoelectric elements are surrounded by the base body part 35A.

Wiring lines 38a, 38b, and 38c are connected to the piezoelectric elements 36A, 36B, and 36C, respectively. The respective wiring lines 38a, 38b, and 38c are introduced into the inside of the base member 35B from the joining surface 38a, extend from the side surface of the base member 35B to the outside, and are electrically connected to the piezoelectric element control unit 38.

The base member 35B is the same member as the base member 25B except that the wiring lines 38a, 38b, and 38c are inserted therethrough. The base body part 35A is joined to a lower surface of the base member 35B, and the elevating arm 9 is connected to an upper surface of the base member 35B.

The piezoelectric element control unit 38 independently supplies driving voltages to the piezoelectric elements 36A, 36B, and 36C, via the wiring lines 38a, 38b, and 38c, respectively.

Accordingly, as the piezoelectric element control unit 38 applies appropriate driving voltages to the piezoelectric elements 36A, 36B, and 36C, respectively, the respective piezoelectric elements 36A, 36B, and 36C can be expanded and contracted independently. As the base body part 35A brought into close contact with the respective piezoelectric elements 36A, 36B, and 36C is deformed with this expansion and contraction, the shape of the molding surface part 5a can be changed.

Target voltage values that allow the reflectivity variation to fall within an allowable range are stored in the piezoelectric element control unit 38 by experimentally investigating the correlation between the occurrence position of reflectivity variation after the formation of the reflection preventing part 2 and the driving voltages of the respective piezoelectric elements 36A, 36B, and 36C, similar to the above second embodiment.

The piezoelectric elements 36A, 36B, and 36C and the piezoelectric element control unit 38 constitute a mold-deforming part that deforms the base body part 35A to bend the molding surface part 5a.

Additionally, the piezoelectric element 36A constitutes a concave deformation part that dents the surface of the base body part so as to face a convex portion of a workpiece. Additionally, the piezoelectric element 36B constitutes a convex deformation part that causes the surface of the base body part to protrude so as to face a concave portion of the workpiece.

For this reason, the present embodiment is an example in which one concave deformation part is provided for one convex portion of a workpiece and one convex deformation part is provided for one concave portion of the workpiece.

Additionally, the present embodiment is an example in which the piezoelectric elements 36B and 36C can form a concave portion by the combination of two convex deformation parts therebetween.

Next, the optical element manufacturing method of the present embodiment using the microstructure forming mold 35 of the present embodiment will be described with a focus on differences from the above second embodiment.

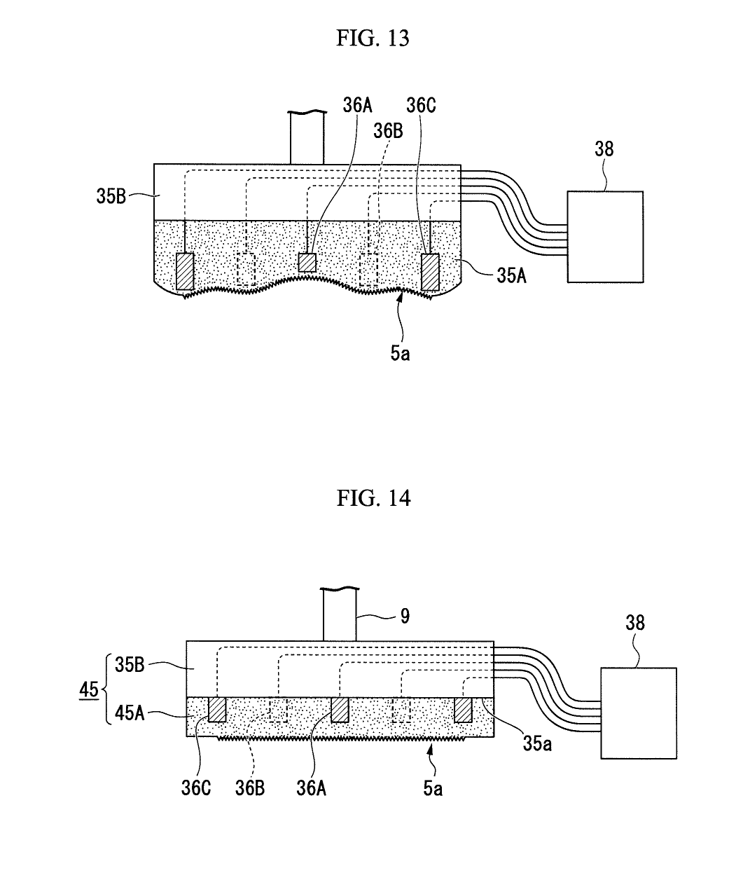

FIG. 13 is an explanatory view of the operation of the microstructure forming mold of the third embodiment of the present invention.

According to the surface processing device 30 of the present embodiment, there is a difference only in that the mold-deforming part has the piezoelectric elements 36A, 36B, and 36C buried in the base body part 35A and the piezoelectric element control unit 38 that controls the expansion and contraction amounts of the piezoelectric elements, and the shape of the molding surface part 5a can be deformed in a shape resembling the aspheric lens surface 21a, similar to the above second embodiment.

That is, as shown in FIG. 13, by the time the microstructure forming mold 35 is pressed against the aspheric lens surface 21a on which the UV-curable resin 16 is coated, the driving voltages of the respective piezoelectric elements are controlled by the piezoelectric element control unit 38 to contract the piezoelectric element 36A and expand the piezoelectric elements 36B and 36C. This allows the molding surface part 5a to be deformed in a shape resembling the aspheric lens surface 21a.

At this time, the thicknesses of the elastic body to the outer surface of the base body part 35A differ at both ends of the respective piezoelectric elements 36A, 36B, and 36C in the expanding/contracting direction. Accordingly, the thicknesses of the elastic body from the respective piezoelectric elements 36A, 36B, and 36C to the outer surface are small, and the molding surface part 5a side where the outer shape is not constrained is conspicuously deformed. Additionally, on the side (base member 35B side) opposite to the molding surface part 5a, the thicknesses of the elastic body from the respective piezoelectric elements 36A, 36B, and 36C to the outer surface are large and the end faces are constrained by the base member 35B. Therefore, even if the deformation amounts of the respective piezoelectric elements 36A, 36B, and 36C differ, there is little deformation amount compared to the molding surface part 5a side.

If the microstructure forming mold 35 in which the molding surface part 5a is deformed is pressed against the aspheric lens surface 21a on which the UV-curable resin 16 is coated, the molding surface part 5a is brought into close contact with the aspheric lens surface 21a. At this time, even when the shape of the molding surface part 5a is different from the aspheric lens surface 21a, a thick layer of a pliable elastic body is present between each of the piezoelectric elements 36A, 36B, and 36C and the base member 35B in the base body part 35A. Therefore, absorption as the strain of the elastic body occurs in a region where the molding surface part already abuts against the aspheric lens surface 21a and the pressing force increases. For this reason, the entire molding surface part 5a can be brought into close contact with the aspheric lens surface 21a by applying an appropriate pressing force.

Except for this, the lens 21A having the reflection preventing part 2 can be manufactured completely similar to the above second embodiment.

According to the present embodiment, since the driving amounts of the respective piezoelectric elements can be finely adjusted, for example, in a minute range that is equal to or lower than micron order, the shape of the molding surface part 5a can be controlled more finely.

Additionally, since the expansion and contraction amounts of the plurality of piezoelectric elements are independently changed to control the shape of the molding surface part 5a, the shape of the molding surface part 5a corresponding to the circumferential directions of the circles C1 and C2 can also be appropriately controlled, by, for example, finely adjusting the expansion and contraction amounts of the respective piezoelectric elements 36B and 36C. For example, even if the manufacture errors of the burial positions of the respective piezoelectric elements 36B and 36C, or the like, occur, shape errors during deformation can be reduced by being corrected with driving voltages.

### Second Modification Example

Next, a microstructure forming mold of a modification example (second modification example) of the third embodiment of the present invention will be described.

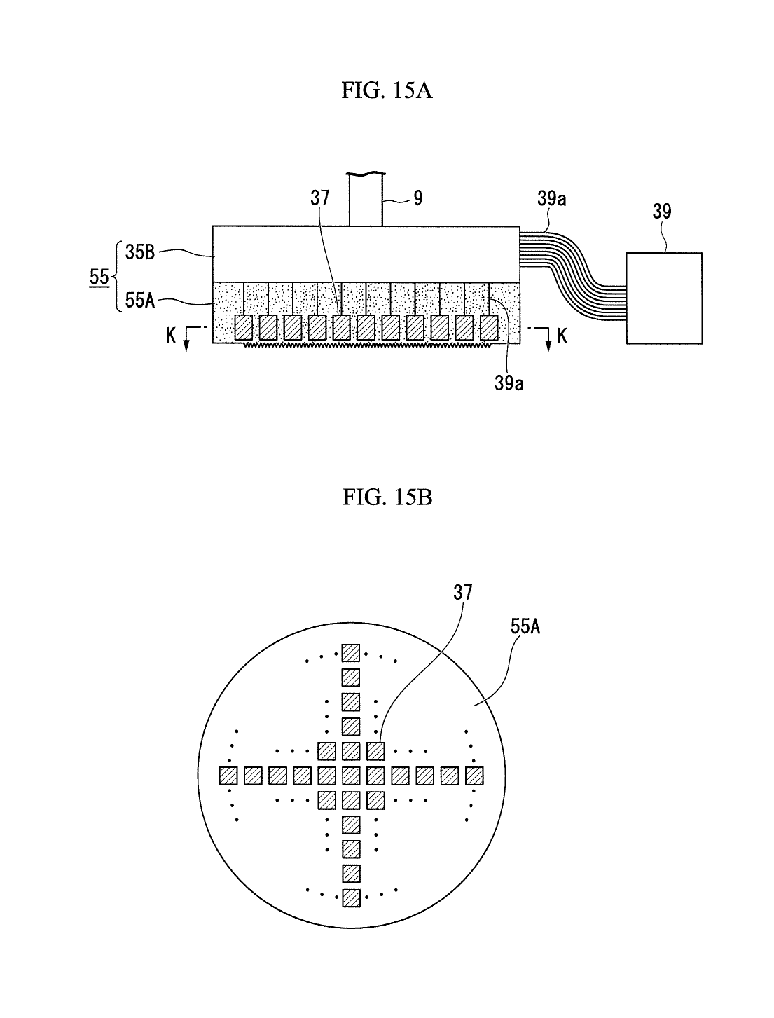

FIG. 14 is a typical configuration view showing the configuration of the microstructure forming mold of the modification example (second modification example) of the third embodiment of the present invention.

A microstructure forming mold 45 of the present modification example, as shown in FIG. 14, includes a base body part 45A instead of the base body part 35A of the microstructure forming mold 35 of the above third embodiment.

The microstructure forming mold 45 can be used instead of the microstructure forming mold 35 in the surface processing device 30 of the above third embodiment.

Hereinafter, differences from the above third embodiment will mainly be described.

The base body part 45A is different from the above base body part 35A in that the piezoelectric elements 36A, 36B, and 36C of the above third embodiment are buried in a state where base end portions thereof abut against the base member 35B.

According to the present modification example, since the positions of the piezoelectric elements 36A, 36B, and 36C at one end thereof are fixed to the base member 35B, expansion and contraction of the piezoelectric elements 36A, 36B, and 36C acts on the elastic body on the molding surface part 5a side. Accordingly, all the expansion and contraction amounts are used to deform the molding surface part 5a. For this reason, target voltage values stored in the piezoelectric element control unit 38 are set as values different from the above third embodiment.

According to the present modification example, the lens 21A can be manufactured substantially similar to the above third embodiment, simply by the base end portions of the respective piezoelectric elements 36A, 36B, and 36C being fixed to the base member 35B.

However, in the present modification example, the base end portions of the respective piezoelectric elements 36A, 36B, and 36C are fixed to the base member 35B. Therefore, when there is a difference between the shape of the aspheric lens surface 21a and the shape of the molding surface part 5a, the difference between the shapes is absorbed by the elastic deformation between the molding surface part 5a and tip portions of the piezoelectric elements 36A, 36B, and 36C.

### Third Modification Example

Next, a microstructure forming mold of another modification example (third modification example) of the third embodiment of the present invention will be described.

FIG. 15A is a typical configuration view of main portions of the microstructure forming mold of another modification example (third modification example) of the third embodiment of the present invention, and FIG. 15B is a K-K cross-sectional view of FIG. 15B.

A microstructure forming mold 55 of the present modification example, as shown in FIGS. 15A and 15B, includes a base body part 55A and a piezoelectric element control unit 39 instead of the base body part 35A and the piezoelectric element control unit 38 of the microstructure forming mold 35 of the above third embodiment.

The microstructure forming mold 55 can be used instead of the microstructure forming mold 35 in the surface processing device 30 of the above third embodiment.

Hereinafter, differences from the above third embodiment will mainly be described.

The base body part 55A is the same as the base body part 35A in terms of outer shape and material, and has more piezoelectric elements 37 densely arranged in a lattice shape in the same posture as the piezoelectric elements 36A, 36B, and 36C instead of the piezoelectric elements 36A, 36B, and 36C.

Wiring lines 39a are connected to the respective piezoelectric elements 37, respectively. The respective wiring lines 39a, similar to the wiring lines 38a, 38b, and 38c of the above third embodiment, are introduced into the inside of the base member 35B, extend from the side surface of the base member 35B to the outside, and are electrically connected to the piezoelectric element control unit 39.

The piezoelectric element control unit 39 independently supplies driving voltages to the piezoelectric elements 37 via the wiring lines 39a.

Accordingly, as the piezoelectric element control unit 39 applies appropriate driving voltages to the respective piezoelectric elements 37, the respective piezoelectric elements 37 can be expanded and contracted independently. As the base body part 55A brought into close contact with the respective piezoelectric elements 37 is deformed with this expansion and contraction, the shape of the molding surface part 5a can be changed.

In the piezoelectric element control unit 39, similar to the above second embodiment, the shape data of the aspheric lens surface 21a is stored and target voltage values of the driving voltages of the respective piezoelectric elements 37 used to deform the molding surface part 5a in a shape resembling the aspheric lens surface 21a are stored.

The piezoelectric elements 37 and the piezoelectric element control unit 39 constitute a mold-deforming part that deforms the base body part 55A to bend the molding surface part 5a.

According to the present modification example, the lens 21A can be manufactured similar to the above third embodiment.

However, in the present modification example, since the number of piezoelectric elements 37 arranged is large compared to the above third embodiment, a plurality of piezoelectric elements 37 in a direction in which irregularities vary are arranged to face a concave portion and a convex portion on the aspheric lens surface 21a, respectively. For this reason, the resolution performance of deformation of the molding surface part 5a is high, and the shape of the molding surface part 5a can be changed to a shape that is more approximated to the shape of the aspheric lens surface 21a by the combination of the expansion and contraction amounts of the plurality of piezoelectric elements 37.

Additionally, even when the surface shapes of workpieces differ, surface shape data is input to the piezoelectric element control unit 39 in advance, so that the shape of the molding surface part 5a can be changed easily and more versatile microstructure forming molds are obtained. For this reason, even when the surface shapes of workpieces vary, manufacture can be continued rapidly without changing to other microstructure forming molds.

Additionally, according to the present modification example, since the piezoelectric element 37 are densely arranged in a lattice shape, the shape of the molding surface part 5a can be easily matched with shapes other than the rotationally symmetric surface shape, for example, a free-form surface or the like.

Although an example in which the optical element that is a workpiece is a lens has been described in descriptions of the respective embodiments and the respective modification examples, the optical element manufactured by the optical element manufacturing method of the present invention is not limited to the lens. For example, optical elements, such as a mirror, a prism, and a filter, may be used.

Additionally, the workpiece in which a microstructure is formed by the microstructure forming mold of the present invention is not limited to the optical element, and machine parts other than the optical element may be used as the workpieces.

Additionally, an example in which the microstructure is the reflection preventing part 2 based on the conical projections 2a has been described in descriptions of the respective embodiments and the respective modification examples. However, a shape of which the refractive index varies in the vicinity of the lens surface may be sufficient in order to form the reflection preventing structure, and pyramidal bodies not only in the conical shape but also in a triangular pyramidal shape, a quadrangular pyramidal shape, and the like, may be favorably adopted.

Additionally, although an example in which the microstructure is the reflection preventing structure has been described in descriptions of the respective embodiments and the respective modification examples, the microstructure is not limited to the pyramidal bodies if the microstructure has a concavo-convex shape formed by the nanoimprint technology. For example, concavo-convex shapes, such as a column, a column hole, a hole shape obtained by reversing a pyramidal body, and a structure (fractal structure) with random projections like the surface of a leaf of a lotus, can be adopted.

For this reason, the microstructure is not limited to the reflection preventing structure.

Additionally, although an example in which the molding surface part in the base body part is formed in a plane region before deformation of the base body part has been described in descriptions of the respective embodiments and the respective modification examples, the molding surface part may be formed on a surface with curvature.

For example, if the molding surface part deformed in a convex (concave) shape by the mold-deforming part is formed on a curved surface with a convex (concave) shape having a larger curvature radius than the curvature radius of the convex (concave) shape after deformation, the strain of the molding surface part after the deformation is small. Therefore, the shape accuracy can be improved. Additionally, durability can be improved.

Additionally, although an example in which the molding surface part 5a is formed from the same material as the base body part on the surface of the base body part has been described in descriptions of the respective embodiments and the respective modification examples, the molding surface part 5a may be formed from a material different from that of the base body part on the surface of the base body part as long as the molding surface part can be deformed together with the base body part.

Additionally, when the molding surface part 5a is formed on the surface layer member 14 and is joined to other members that constitute the base body part, the material of the surface layer member 14 and the materials of other members that constitute the base body part may be different from each other as long as the base body part and the molding surface part 5a are deformable.

Additionally, although an example in which a workpiece is fixed to the holding part 3 and the microstructure forming mold is elevated to press the microstructure forming mold against the workpiece has been described in descriptions of the respective embodiments and the respective modification examples, the position of the microstructure forming mold may be fixed so that the holding part 3 can be elevated, and the workpiece held by the holding part 3 may be pressed against the microstructure forming mold.

Additionally, although an example in which the UV light source 4 is arranged below the holding part 3 and the UV-curable resin 16 is cured with UV light transmitted through the workpiece has been described in descriptions of the respective embodiments and the respective modification examples, for example, the UV light may be emitted from a side of the workpiece.

Additionally, when the microstructure forming mold is made of a UV-light-transmittable material, for example, the UV light source may be provided above the microstructure forming mold or inside the microstructure forming mold, and the UV-curable resin 16 may be cured with UV light transmitted through the microstructure forming mold.

Additionally, although an example in which the base body part is deformed by fluid pressure and an example in which the base body part is deformed by the expansion and contraction of the piezoelectric elements have been described as the mold-deforming part that deforms the base body part in descriptions of the respective embodiments and the respective modification examples, the mold-deforming part is not limited to these. For example, a pressing member that advances and retracts with respect to the molding surface part may be provided instead of the piezoelectric elements, and mechanical pressure may be applied to the base body part from the pressing member so as to deform the base body part.

Additionally, all the constituent elements described in the above embodiments may be carried out by appropriate combinations or omissions within the scope of the technical idea of the present invention.

For example, according to the configurations of the microstructure forming molds of the above second and third embodiments and respective modification examples, the number of mold-deforming parts is larger compared with that of the microstructure forming mold 5 of the above first embodiment. Therefore, the microstructure forming molds can also be favorably used for workpieces with less concavo-convex shapes, such as the same concave spherical surface or convex spherical surface as the above first embodiment.

For example, in order to form a shape resembling the concave lens surface 1a with the microstructure forming mold 25, a shape with a convex spherical surface may be formed by expanding the cavity portion 26 and the annular cavity portion 27 and contracting the annular cavity portion 28.

1. A microstructure forming mold that a microstructure having a concave portion and a convex portion is formed on a surface of a workpiece including the surface with a curvature, the microstructure forming mold comprising:
a molding surface part which transfers the microstructure;
a base body part which supports the molding surface part in a bendable manner; and
a mold-deforming part which causes the base body part to be deformed and which causes the molding surface part to be bent.

2. The microstructure forming mold according to claim 1,
wherein the molding surface part is processed into a shape that transfers the microstructure to the surface of the base body part.

3. The microstructure forming mold according to claim 1,
wherein the mold-deforming part includes at least one of a convex deformation part that causes the surface of the base body part to protrude so as to face the concave portion of the workpiece, and a concave deformation part that dents the surface of the base body part so as to face the convex portion of the workpiece.

4. The microstructure forming mold according to claim 1,
wherein the mold-deforming part includes:
a volume changing chamber which contains a fluid inside the base body part and allows at least one of an increase and a reduction of volume according to a change in a pressure of the fluid; and
a pressure control part which changes the pressure of the fluid within the volume changing chamber.

5. The microstructure forming mold according to claim 4,
wherein the base body part is configured by bonding a plurality of members that form the volume changing chamber.

6. The microstructure forming mold according to claim 1,
wherein the microstructure is a reflection preventing structure in which pyramidal bodies are assembled.

7. An optical element manufacturing method comprising:
forming an optical element main body that is a workpiece having an optical surface with a curvature on a surface thereof;
coating molding resin on the optical surface; and
pressing the molding surface part of the microstructure forming mold against the optical surface via the molding resin and transferring the shape of the molding surface part of the microstructure forming mold to the molding resin to thereby form the microstructure on the optical surface, in a state where the molding surface part is deformed in a shape resembling the shape of the optical surface by the mold-deforming part of the microstructure forming mold according to claim 1.

8. An optical element manufacturing method comprising:
forming an optical element main body that is a workpiece having an optical surface with a curvature on a surface thereof;
coating molding resin on the optical surface; and
pressing the molding surface part of the microstructure forming mold against the optical surface via the molding resin and transferring the shape of the molding surface part of the microstructure forming mold to the molding resin to thereby form the microstructure on the optical surface, in a state where the molding surface part is deformed in a shape resembling the shape of the optical surface by the mold-deforming part of the microstructure forming mold according to claim 2.

9. An optical element manufacturing method comprising:
forming an optical element main body that is a workpiece having an optical surface with a curvature on a surface thereof;
coating molding resin on the optical surface; and
pressing the molding surface part of the microstructure forming mold against the optical surface via the molding resin and transferring the shape of the molding surface part of the microstructure forming mold to the molding resin to thereby form the microstructure on the optical surface, in a state where the molding surface part is deformed in a shape resembling the shape of the optical surface by the mold-deforming part of the microstructure forming mold according to claim 3.

10. An optical element manufacturing method comprising:
forming an optical element main body that is a workpiece having an optical surface with a curvature on a surface thereof;
coating molding resin on the optical surface; and
pressing the molding surface part of the microstructure forming mold against the optical surface via the molding resin and transferring the shape of the molding surface part of the microstructure forming mold to the molding resin to thereby form the microstructure on the optical surface, in a state where the molding surface part is deformed in a shape resembling the shape of the optical surface by the mold-deforming part of the microstructure forming mold according to claim 4.

11. An optical element manufacturing method comprising:
forming an optical element main body that is a workpiece having an optical surface with a curvature on a surface thereof;
coating molding resin on the optical surface; and
pressing the molding surface part of the microstructure forming mold against the optical surface via the molding resin and transferring the shape of the molding surface part of the microstructure forming mold to the molding resin to thereby form the microstructure on the optical surface, in a state where the molding surface part is deformed in a shape resembling the shape of the optical surface by the mold-deforming part of the microstructure forming mold according to claim 5.

12. An optical element manufacturing method comprising:
forming an optical element main body that is a workpiece having an optical surface with a curvature on a surface thereof;
coating molding resin on the optical surface; and
pressing the molding surface part of the microstructure forming mold against the optical surface via the molding resin and transferring the shape of the molding surface part of the microstructure forming mold to the molding resin to thereby form the microstructure on the optical surface, in a state where the molding surface part is deformed in a shape resembling the shape of the optical surface by the mold-deforming part of the microstructure forming mold according to claim 6.
